(19) United States
(12) Patent Application Publication
(10) Pub. No.: US 2003/0151308 A1
(43) Pub. Date: Aug. 14, 2003

(54) Systems and methods for indicating events in a power distribution system

(76) Inventor: Kirk S. Thomas, Escondido, CA (US)

Correspondence Address: JACKSON PATENT LAW OFFICE, 211 NORTH UNION STREET, SUITE 100, ALEXANDRIA, VA, 22314, US

(21) Appl. No.: 10/314,489

(22) Filed: Dec. 9, 2002

Related U.S. Application Data
(60) Provisional application No. 60/336,723, filed on Dec. 7, 2001.

(51) Int. Cl. H02J 1/00

(52) U.S. Cl. 307/11

(57) ABSTRACT

Disclosed are diagnostic tools and methods for a power distribution system.

This Application claims the benefit of Application Serial No. 60/336,723 of KIRK S. THOMAS filed Dec. 7, 2001 for SYSTEMS AND METHODS FOR INDICATING EVENTS IN A POWER DISTRIBUTION SYSTEM, the contents of which are herein incorporated by reference.

### BACKGROUND OF THE INVENTION

1. Field of the Invention

This invention relates generally to power distribution systems and, more particularly, to systems and methods of detecting and recording conditions at various locations in a power distribution system throughout a wide geographic area.

2. Description of Related Art

Malfunctions in power distribution systems are often accompanied by transient anomalies in certain locations of the system. To isolate and diagnose a malfunction, technicians may be dispatched to inspect various locations in the system. Because these anomalies may be transient, however, these anomalies cannot be used as a diagnostic clue without equipment to record the occurrence of these anomalies.

### SUMMARY OF THE INVENTION

It is an object of the present invention to provide diagnostic tools and methods for a power distribution system.

To achieve this and other objects of the present invention, there is a method for a power distribution system including a generation station and a plurality of circuits each located away from the generation station. The method comprises the steps, performed for each circuit, of detecting an excess current at a respective location in the power distribution system; detecting a loss of voltage at the respective location; and conditionally signaling a fault condition depending on whether the second detecting step follows the first detecting step within a predetermined time.

According to another aspect of the present invention, there is a method for a power distribution system. The method comprises the steps, performed at a first location, of detecting an excess current in a first line in the plurality of lines; and responsive to the previous step, breaking the current path in each line of the plurality of lines, and the following steps, performed at a location removed from the first location, detecting an excess current in a first line in the plurality of lines; detecting a loss of voltage in the first line; and conditionally signaling a fault condition depending on whether the second detecting step follows the first detecting step within a predetermined time.

### BRIEF DESCRIPTION OF THE DRAWINGS

FIG. 1 is a diagram of a power distribution system employing a recording device in accordance with a first preferred embodiment of the invention.

FIG. 2 is diagram describing circuitry in the recording device of the first preferred embodiment.

FIG. 3 is a timing diagram for describing an operation of the first preferred recording device.

FIG. 4 is another timing diagram for describing another feature of the first preferred recording device.

FIG. 5 is another timing diagram for describing yet another feature of the preferred recording device.

FIG. 6 is a diagram emphasizing a housing of recording device in accordance with a second embodiment of the present invention.

FIG. 7 is a diagram of a circuit in the housing shown in FIG. 6.

FIG. 8 is a chart of specifications for the second preferred recording device.

FIG. 9 shows a recordation device in accordance with a third preferred embodiment of the present invention.

FIG. 10 is a diagram emphasizing a housing of a recording device in accordance with a fourth preferred embodiment of the present invention.

FIG. 11 is a diagram of the recording device in accordance with the fourth preferred embodiment.

FIG. 12 is a chart of specifications for the recording device of the fourth preferred embodiment.

The accompanying drawings which are incorporated in and which constitute a part of this specification, illustrate embodiments of the invention and, together with the description, explain the principles of the invention, and additional advantages thereof.

### DESCRIPTION OF THE PREFERRED EMBODIMENTS

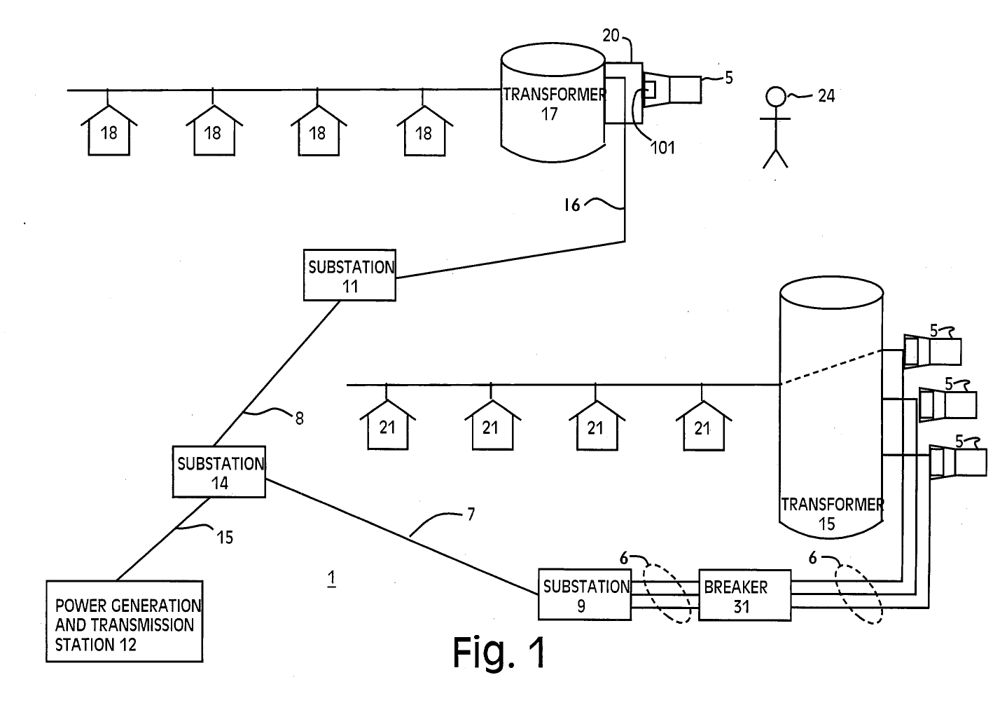

FIG. 1 shows the United States power distribution system 1 configured with electrical recordation device 5 in accordance with a first preferred embodiment of the present invention. Power generation and transmission station 12 may be a hydroelectric power station, a fuel burning power station, or a wind power station, for example. Station 12 generates a high voltage power signal and transmits the signal over transmission lines 15, 8, and 7; and substations 14, 11, and 9. Substations 14, 11, and 9 act to step down the voltage generated by station 12. Substation 11 sends a power signal to transformer 17 via cable 16. Transformer 17 steps down the voltage received on cable 16 and transmits a 110 VAC power signal to homes 18.

Substation 9 sends 3 phases of power signal to transformer 15 via cables 6. Transformer 15 steps down the voltages received on cables 6. Transformer 15 transmits a single phase 110 VAC power signal to homes 21, as represented by the dotted line between the phase, monitored by one of the devices 5, and homes 21.

Circuit breaker 31 is between substation 9 and transformer 15. When circuit breaker 31 detects a fault on any of the three phases, circuit breaker 31 opens the current path for each of the 3 phases between substation 9 and transformer 15. Subsequently, after a certain time, circuit breaker 31 recloses each of the current path.

In the event of a current surge in a conductor, such as cable 16 or cable 6, a recordation device 5 detects the surge and, in response to the detected surge, sets or trips an output display of device 5.

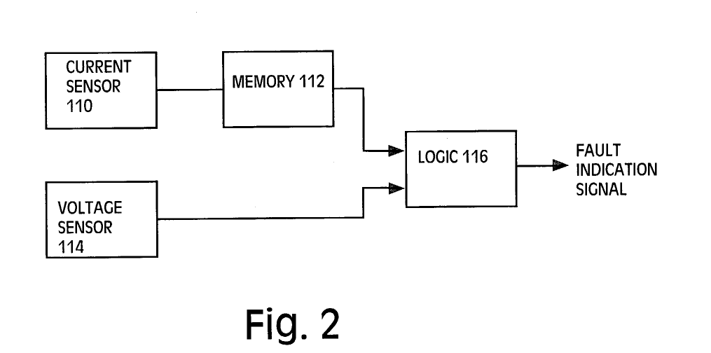

FIG. 2 shows circuitry in device 5. In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

Current sensor 110 senses current in line 16 and stores a result in memory 112. Memory 112 thus records whether an excess current has existed in line 16 for at least a certain internal. This interval could be 0.001 seconds, for example.

Memory 112 also records whether the excess current was detected within a certain interval, spanning from a time in the past to the present. For example, memory 112 could record whether the excess current was detected within the previous 30 seconds. Alternately, memory 112 could record whether the excess current was detected within the previous 5 seconds. It is presently preferred that memory 112 be configured to at least indicate whether the excess current was detected with the previous 100 milliseconds, thereby coordinating with conventional circuit breakers.

Voltage sensor 114 senses a loss of voltage on line 16.

Logic 116 processes outputs from memory 112 and voltage sensor 114, to produce a fault indication signal. In the example of circuit 5, this fault indication signal drives an output device that is visible to a technician, such as technician 24.

Device 5 may assume a variety of forms. For example, memory 112 may include a log of sensed current, with each log entry having a time stamp or some other association with time.

Alternately, device 5 may include dedicated circuits to minimize the total hardware in circuit 5. For example, memory 112 may be merely a single bit and device 5 may include a circuit to reset the bit after a certain internal, such as 5 seconds or 30 seconds. In this case, logic 116 may be merely an AND gate.

Device 5 includes circuitry to inhibit generation of the fault indication signal until approximately at least 3 minutes from powering of the monitored line. This inhibiting may take a variety of forms. For example, current sensor 110 may be inhibited or, alternately, a three minute timing signal may be gated further downstream toward logic 116.

Thus, device 5 implements 3 conditions for the indication of a fault.

The first condition is that circuit 28 be powered from line being monitored, for at least 3 minutes to become operational.

The second condition is that circuit 28 sense an over current condition (a predetermined current level, factory set) in the line being monitored. It is presently preferred that the over current condition have a duration of at least 0.001 seconds.

The third condition is that circuit 28 sense loss of voltage in the line being monitored within 30 seconds after sensing the over current condition.

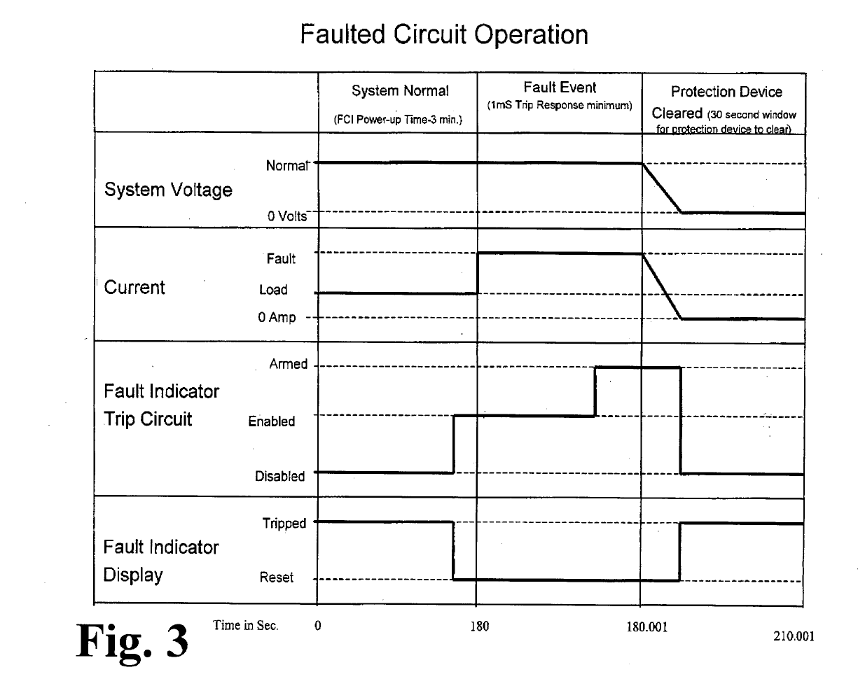

FIG. 3 is a timing diagram for describing an operation of device 5.

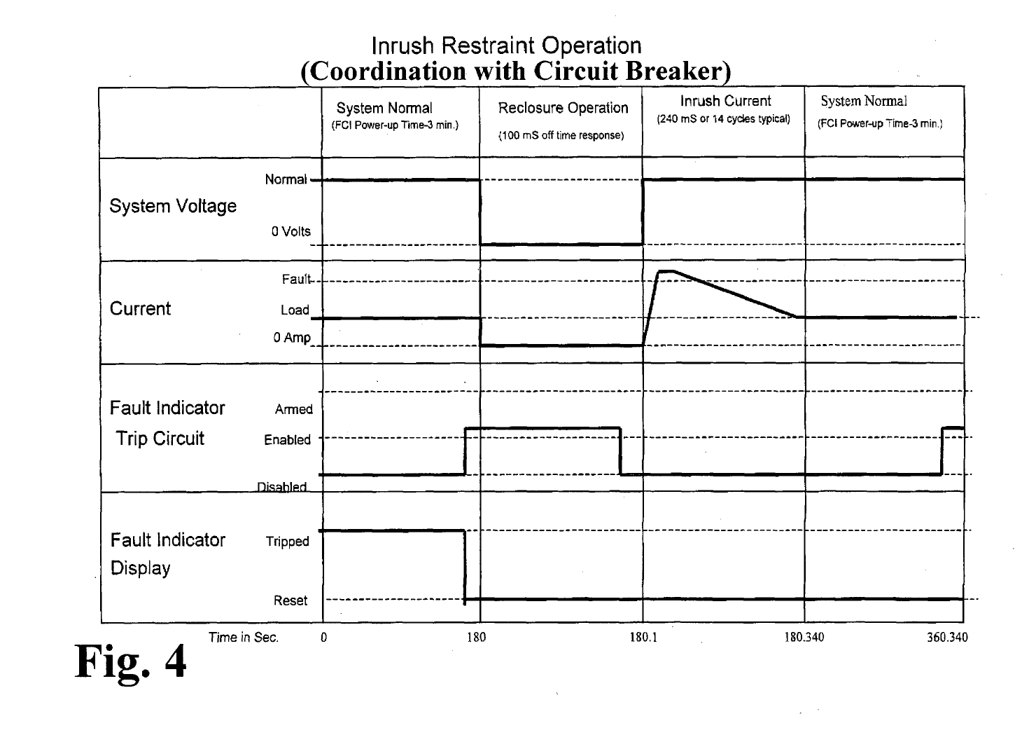

FIG. 4 is another timing diagram for describing another feature of device 5. When a circuit breaker, such as breaker 31, recloses a current path after and outage, there is excess current. Because voltage sensor 114 and logic 116 do not detect loss of voltage within 30 seconds after the excess current, however, logic 116 does not generate a fault indication signal indicating “tripped.”

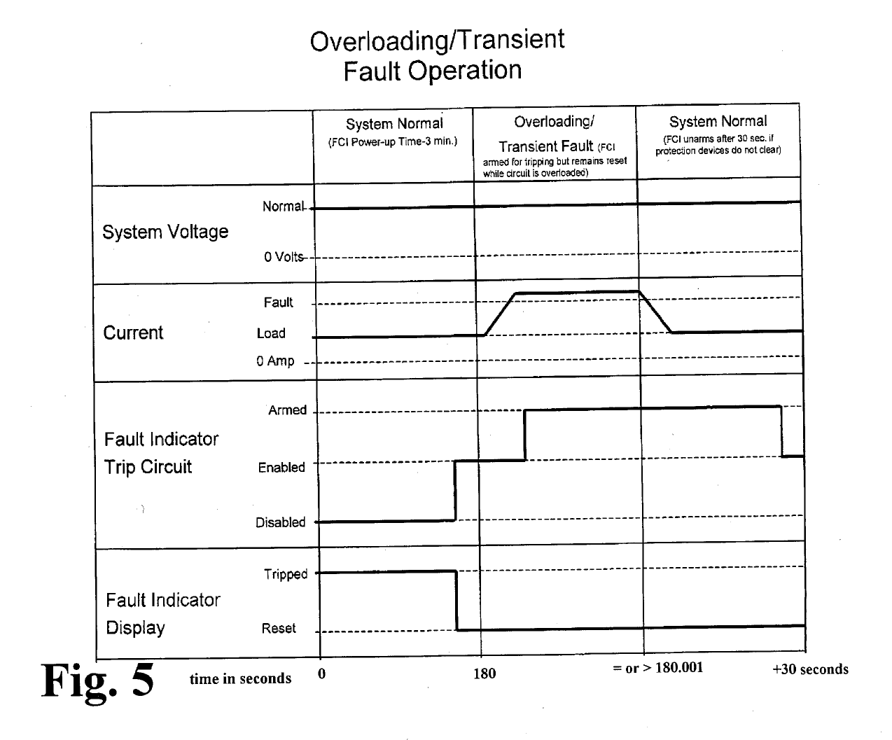

FIG. 5 is another timing diagram for describing another feature of device 5. After 180 seconds, device 5 operates normally. Subsequently, currents sensor 110 detects excess current. Because voltage sensor 114 and logic 116 do not detect loss of voltage within 30 seconds after the excess current, however, logic 116 does not generate a fault indication signal indicating “tripped.”

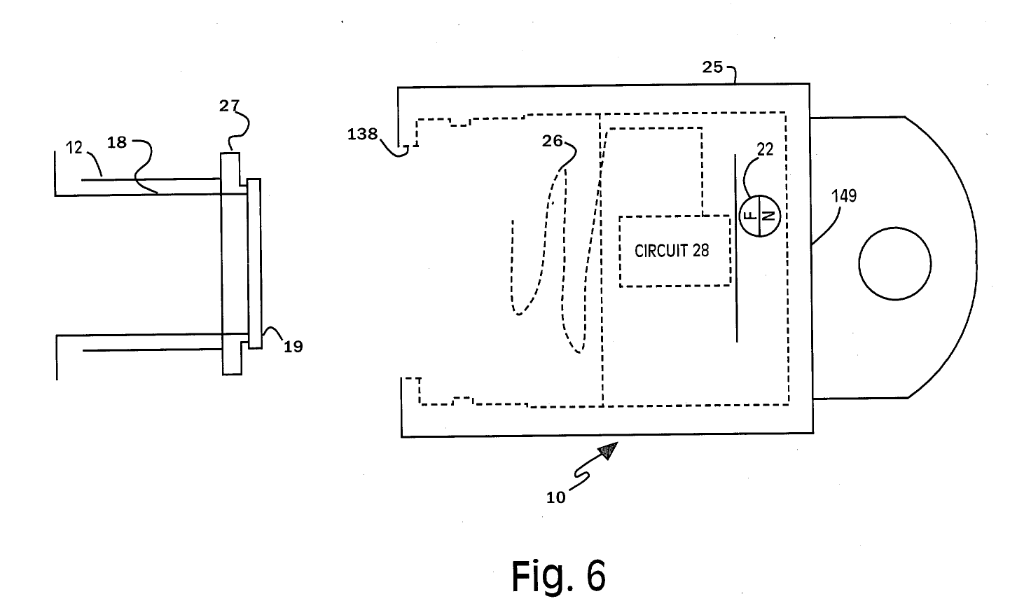

FIG. 6 is a diagram emphasizing a housing of recording device 10 in accordance with a second embodiment of the present invention. Device 10 may be located in a system such as system 1, in place of devices such as device 5.

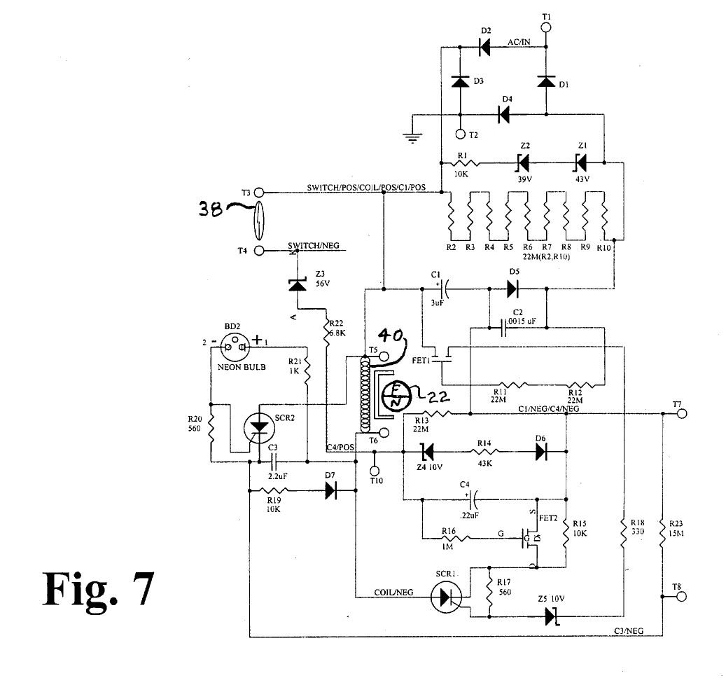

FIG. 7 shows a circuit 28 of the recordation device 10 in accordance with the second preferred embodiment. In this second preferred embodiment, indicator 22 is an electromechanical flag. Device 10 maintains indicator 22 in the trip position until system conditions permit device 10 to automatically reset indicator 22. Thus, technician 24, who is inspecting various parts of distribution system 1, may observe the state of indicator 22 and be thus informed of the current surge that occurred on cable 16.

Device 10, includes housing 25. Housing 25 includes resilient end portion 138. End portion 138 is a resilient rubber or plastic material for connecting over a test point of a conventional transformer connecter widely used in the United States. In other words, housing end portion 138 acts to mechanically couple device 10 to a transformer connector and to power cable 16. Metallic spring 26 is electrically connected to circuit 28 at the cathode of diode D1, terminal 1 (T1), in housing 25. When device 10 is mechanically coupled to the test point in the transformer connector, spring 26 is electrically coupled to a contact 19 in the transformer connector.

Test point terminal 101 is integral to conventional transformer connecters widely used in the United States. Test point terminal 101 includes a projection 27 of insulating member 12 protruding from connector 20. Embedded in test point terminal 101 is an electrically conductive contact 18 having an annular outer flange portion 19 exposed at the outer end of the terminal to provide an electrical connection to the contact and an inner portion in proximity to conductor 16 to capacitively couple circuit 28 to cable 16.

A method for accommodating various sized test point terminals is disclosed in U.S. application Ser. No. 09/709,575 of KIRK S. THOMAS filed Nov. 13, 2000 for SYSTEMS AND METHODS FOR INDICATING EVENTS IN A POWER DISTRIBUTION SYSTEM, the contents of which are herein incorporated by reference.

Device 10 includes housing 25. Housing 25 defines a cavity that accommodates annular rib 27 and annular contact 19 of test point 16. Metallic spring 26 is in the cavity and is electrically connected to circuit 28 in housing 25. When device 10 is mechanically coupled to the test point in the transformer connector, spring 26 is electrically coupled to a contact 19 in the transformer connector.

Housing 25 defines transparent window 149, facilitating viewing of indicator 22.

Contact 19, of connector 20, is in proximity to cable 16 such that contact 19 is capacitively coupled to cable 16. Thus, circuit 28 is capacitively coupled to cable 16.

Circuit 28 is powered by contact 19. Circuit 28 automatically senses and displays a faulted circuit condition, via electromechanical flag 22. Flag 22 has two positions, “N” indicating normal and “F” indicating fault. Circuit 28 includes an automatic reset feature that returns flag 22 from the fault position to the normal position, after system voltage restoration.

Reed switch 38 is oriented and located such that it will be closed by the magnetic field generated by cable 16. Optimally, switch 38 is oriented perpendicular to the magnetic field from cable 16. On the occurrence of a current surge on cable 16, magnetic reads switch 38 effectively detects the excessive current in cable 16 and switch 38 thus closes for the duration of the surge. The duration of the surge is typically in a range 0.001 to 10 seconds. Subsequently, circuit 28 conditionally activates coil 40 to change the position of electromechanical indicator flag 22, depending on certain conditions.

Circuit 28 may be configured to resist false trips caused by inrush, overload, cold load pick up, or adjacent phase proximity effects.

Circuit 28 indicates a fault only when there has been an excessive current in the line being monitored, i.e., faulted circuit or conductors shorted to ground, followed by the line becoming de-energized within 30 seconds after sensing the faulted circuit.

Circuit 28 co-ordinates fault indication with the protection devices, (fuses, circuit breakers or automatic reclosures) by only tripping when fault currents are substantial enough to operate associated protection devices. Circuit 28 avoids fault indication if protection devices do not operate, thus preventing false indications due to transient currents, overloading or inrush currents.

It is presently preferred that circuit 28 employ logic that establishes 3 conditions for the indication of a faulted circuit.

The first condition is that circuit 28 be powered from line being monitored, for at least 3 minutes to become operational.

The second condition is that circuit 28 sense an over current condition (a predetermined current level, factory set) in the line being monitored. It is presently preferred that the over current condition have a duration of at least 0.001 seconds.

The third condition is that circuit 28 sense loss of voltage in the line being monitored within 30 seconds after sensing the over current condition.

An explicit description of the operation of the circuit of FIG. 7 is inherent in FIG. 7. As is apparent, for example, D1, D2, D3, and D4 are diodes configured as a bridge rectifier that converts the AC signal on test point terminal T1 into a DC signal. R1, Z1, and Z2, limit this DC signal to 82 VDC. R2, R3, R4, R5, R6, R7, R8, R9, and R10 are a bank of 22 Mega ohm resistors that provide a path for C1 to charge C2 during a loss of system voltage.

Diode D5 allows C1 to charge while limiting C2 to 0.7 VDC. Capacitor C2 controls when FET1 turns on. After circuit 28 is energized for at least 3 minutes, C2 will turn FET1 on when a loss of system voltage occurs causing test point terminal T1 to lose voltage. During a loss of voltage event, C1 charge C2 through the resistor bank R2, R3, R4, R5, R6, R7, R8, R9, and R10. When C2 reaches approximately 3 VDC, FET 1 turns on and sends a signal from C1 to SCR 1 via R18 and Z5. This signal causes SCR 1 to turn on, allowing C1 to discharge through coil 40, SCR 1, and R15 or FET 2.

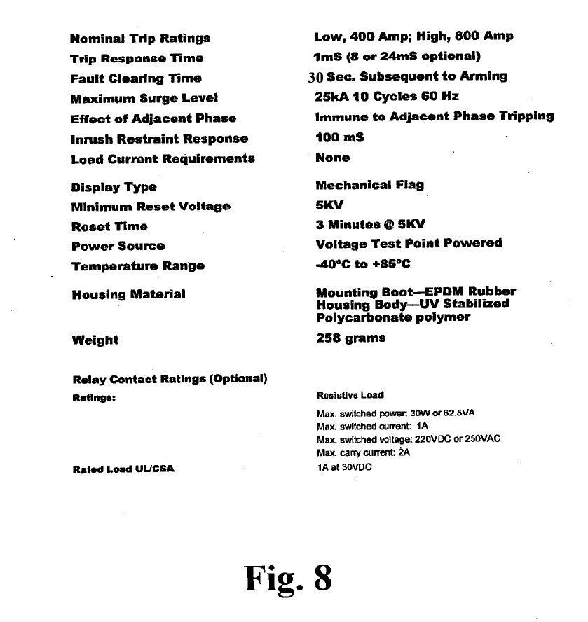

FIG. 8 is a chart of specifications for the recording device.

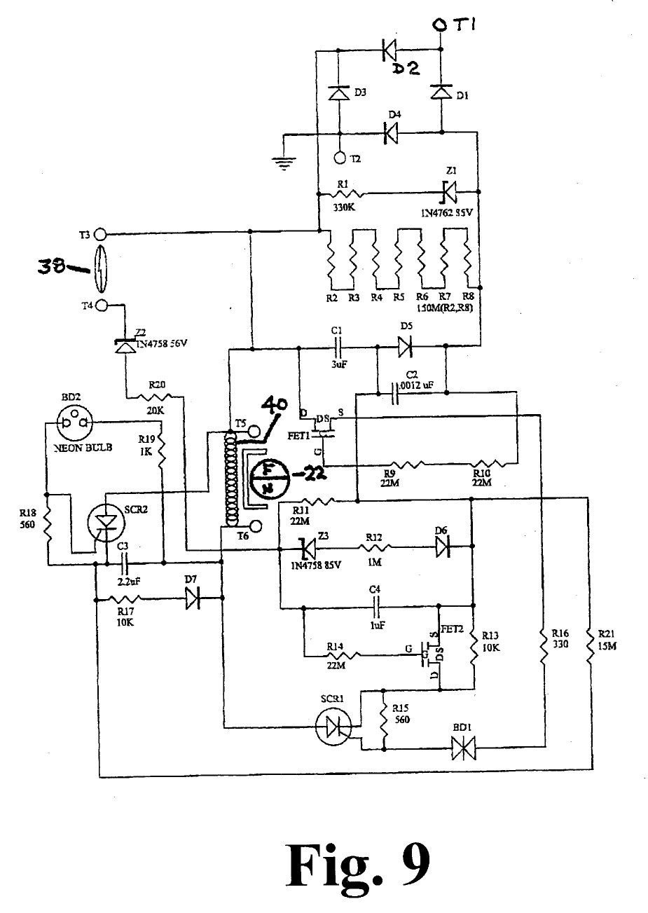

FIG. 9 shows a recordation device in accordance with a third preferred embodiment of the present invention. A difference between this third preferred device and the second preferred device is that the window for sensing loss of voltage is only 5 seconds after sensing over current, instead of 30 seconds.

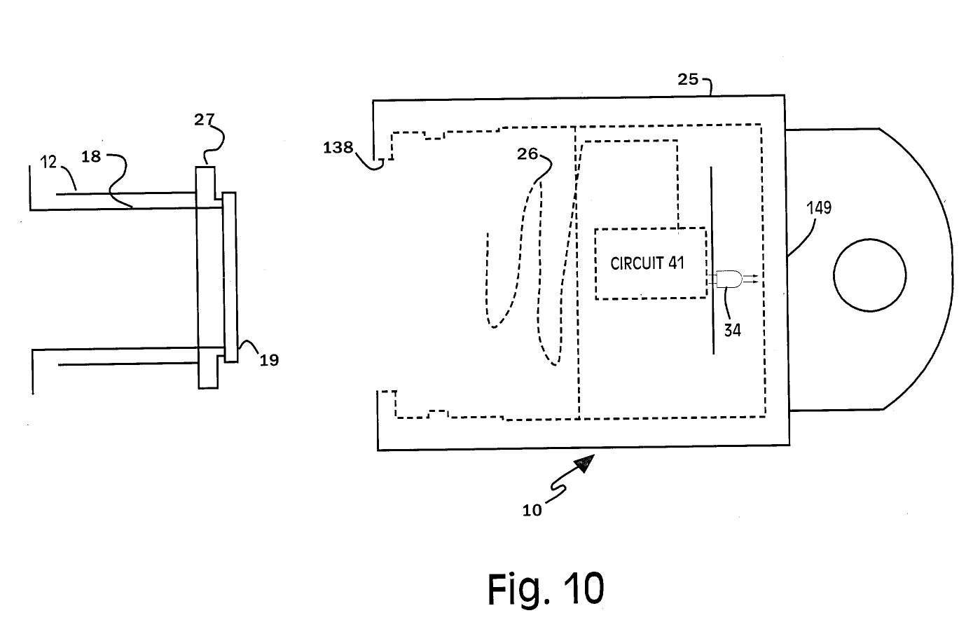

FIG. 10 is a diagram emphasizing a housing of a recording device in accordance with a fourth preferred embodiment of the present invention.

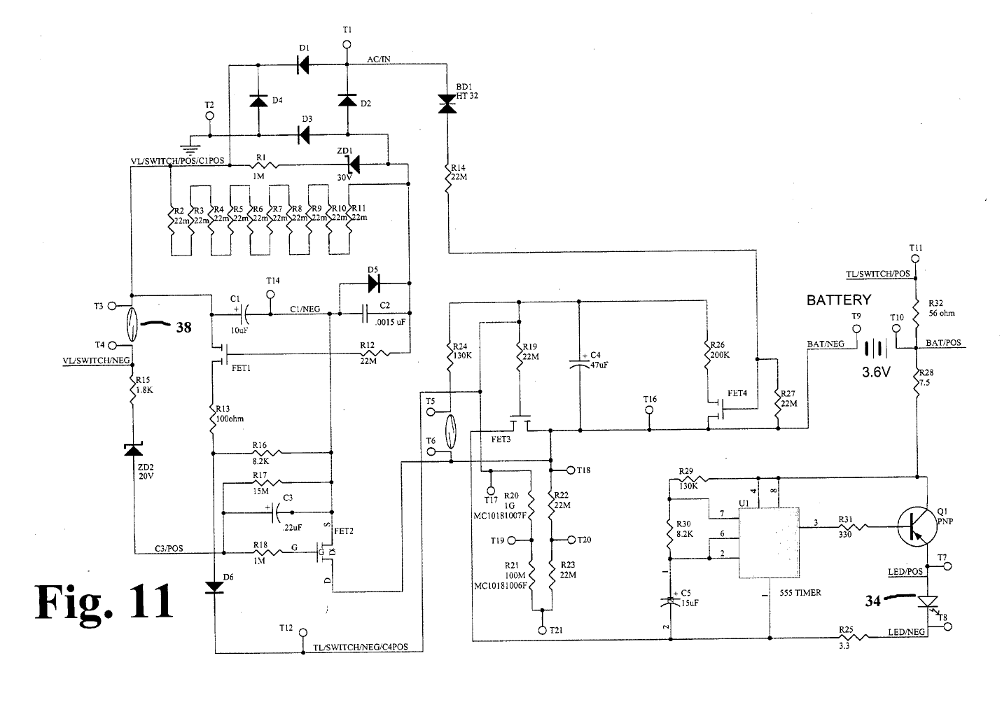

FIG. 11 is a diagram of circuit 41 of the recording device in accordance with the fourth preferred embodiment of the present invention. The circuit of FIG. 11 employs a blinking light emitting diode, indicator 34, instead of an electromechanical flag for fault indication. In the event of a current surge in a conductor, such as cable 16 or cable 6, the recordation device detects the surge and, in response to the detected surge and other conditions being met, activates indicator 34, which is an output display of device 10. Device 10 maintains indicator 34 in the blinking or trip mode until system conditions permit device 10 to automatically deactivate or reset indicator 34 or until a duration of 4 hours has elapsed. Thus, technician 24, who is inspecting various parts of distribution system 1, may observe the state of indicator 34 and be thus informed of the current surge that occurred on cable 16.

Housing end portion 138 acts to mechanically couple device 10 to a transformer connector and to power cable 16. Metallic spring 26 is electrically connected to circuit 41 at the cathode of diode D2, terminal 3 (T3), in housing 25. When device 10 is mechanically coupled to the test point in the transformer connector, spring 26 is electrically coupled to a contact 19 in the transformer connector.

Embedded in test point terminal 101 is an electrically conductive contact 18 having an annular outer flange portion 19 exposed at the outer end of the terminal to provide an electrical connection to the contact and an inner portion in proximity to conductor 16 to capacitively couple circuit 41 to cable 16.

Device 10 includes housing 25. Housing 25 defines a cavity that accommodates annular rib 27 and annular contact 19 of test point 16. Metallic spring 26 is in the cavity and is electrically connected to circuit 41 in housing 25. When device 10 is mechanically coupled to the test point in the transformer connector, spring 26 is electrically coupled to a contact 19 in the transformer connector.

Housing 25 defines transparent window 149, facilitating viewing of indicator 34.

Contact 19, of connector 20, is in proximity to cable 16 such that contact 19 is capacitively coupled to cable 16. Thus, circuit 41 is capacitively coupled to cable 16.

Contact 19 and a 3.6-volt lithium cell power circuit 41. Circuit 41 automatically senses and displays a faulted circuit condition, via blinking LED 34. Circuit 41 includes an automatic reset feature that returns LED 34 to a reset, non-flashing condition, after system voltage restoration or after 4 hours.

Reed switch 38 is oriented and located such that it will be closed by the magnetic field generated by cable 16. Optimally, switch 38 is oriented perpendicular to the magnetic field from cable 16. On the occurrence of a current surge on cable 16, magnetic reads switch 38 effectively detects the excessive current in cable 16 and switch 38 thus closes for the duration of the surge. The duration of the surge is typically in a range 0.001 to 10 seconds. Subsequently, circuit 41 conditionally activates LED 34, depending on certain conditions.

Circuit 41 may be configured to resist false trips caused by inrush, overload, cold load pick up, or adjacent phase proximity effects.

Circuit 41 indicates a fault only when there has been an excessive current in the line being monitored, i.e., faulted circuit or conductors shorted to ground, followed by the line becoming de-energized within 30 seconds after sensing the faulted circuit.

Circuit 41 co-ordinates fault indication with the protection devices, (fuses, circuit breakers or automatic reclosures) by only tripping when fault currents are substantial enough to operate associated protection devices. Circuit 41 avoids fault indication if protection devices do not operate, thus preventing false indications due to transient currents, overloading or inrush currents.

It is presently preferred that circuit 41 employ logic that establishes 3 conditions for the indication of a faulted circuit.

The first condition is that circuit 41 be powered from line being monitored, for at least 3 minutes to become operational.

The second condition is that circuit 41 sense an over current condition (a predetermined current level, factory set) in the line being monitored. It is presently preferred that the over current condition have a duration of at least 0.001 seconds.

The third condition is that circuit 41 sense loss of voltage in the line being monitored within 30 seconds after sensing the over current condition.

One of the optional features in circuit 41 is the reed switch between terminals T5 and T6. This reed switch may be manipulated with a magnetic tool carried by a technician, thereby resetting circuit 41 manually.

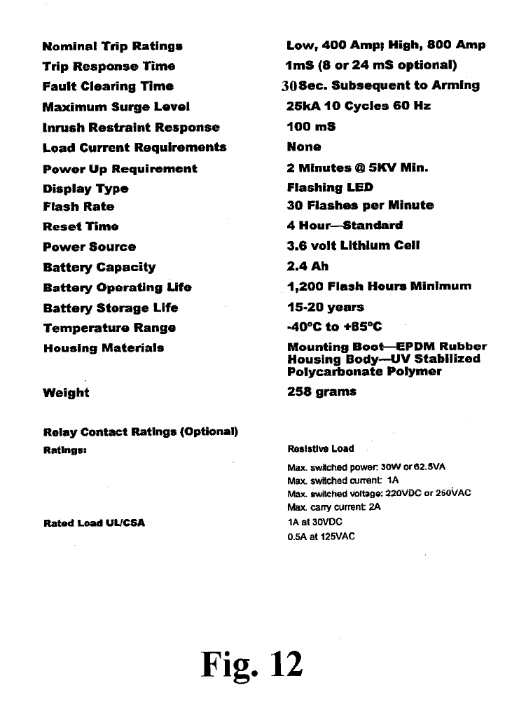

FIG. 12 is a chart of specifications for the recording device of the second preferred embodiment of the present invention

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

Given the foregoing, it should be apparent that the specific described embodiments are illustrative and not intended to be limiting. Furthermore, variations and modifications to the preferred embodiment of the invention should now be apparent to a person having ordinary skill in the art. These variations and modifications are intended to fall within the scope and spirit of the preferred embodiment of the invention as defined by the following claims.

What is claimed is:

1. A method for a power distribution system including a generation station and a plurality of circuits each located away from the generation station, the method comprising the steps, performed for each circuit, of:
detecting an excess current at a respective location in the power distribution system;
detecting a loss of voltage at the respective location; and
conditionally signaling a fault condition depending on whether the second detecting step follows the first detecting step within a predetermined time.

2. The method of claim 1 wherein detecting the excess current includes detecting a signal from a magnetic switch.

3. The method of claim 1 wherein signaling a fault includes moving a mechanical indicator.

4. The method of claim 1 wherein signaling a fault includes generating a light signal.

5. The method of claim 1 wherein detecting a loss of voltage includes capacitivley coupling to a power line.

6. The method of claim 1 wherein system includes a memory and detecting an excess current includes detecting a current to store a detection result in the memory.

7. The method of claim 1 wherein the predetermined time is 100 milliseconds.

8. A method for a power distribution system, the method comprising the steps, performed at a first location, of:
detecting an excess current in a first line in the plurality of lines; and
responsive to the previous step, breaking the current path in each line of the plurality of lines,
and the following steps, performed at a location removed from the first location, detecting an excess current in a first line in the plurality of lines;
detecting a loss of voltage in the first line; and
conditionally signaling a fault condition depending on whether the second detecting step follows the first detecting step within a predetermined time.
